(19) United States
(12) Patent Application Publication
(10) Pub. No.: US 2026/0278571 A1
(43) Pub. Date: Sep. 17, 2026

(54) TOKEN MANAGING SYSTEM AND A METHOD OF MANAGING TOKENS

(71) Applicant: Intree ApS, Frederiksberg (DK)

(72) Inventors: Jacob Wolff-Petersen, Il-Birgu (MT); Jonathan WOLFF-PETERSEN, Copenhagen S (DK); LARS KÆRAA LÜCKE, Frederiksberg C (DK); MIKKEL VASE FREDERIKSEN, Copenhagen S (DK)

(73) Assignee: Intree ApS, Frederiksberg (DK)

(21) Appl. No.: 19/167,665

(22) PCT Filed: Mar. 19, 2024
(86) PCT No.: PCT/EP2024/057317

§ 371 Date: Sep. 22, 2025

(30) Foreign Application Priority Data
Mar. 24, 2023 (DK) PA202300273

(51) Int. Cl. G06Q 20/10

(52) U.S. Cl. CPC G06Q 20/10

(57) ABSTRACT

The present invention relates to a token managing system and method for managing tokens, said system comprising a token control server with a token database and where the system further comprises a plurality of token handling clients for handling said tokens, each token handling client being uniquely identifiable via a client ID, wherein tokens are defined in the token database of the token control server and each token comprises the following data elements: —a token ID element uniquely identifying said token, —a token description element describing features of said token, 13 a token handler list element identifying the client ID of a plurality of token handling clients, said token handling clients identify a handler specific list of available tokens, said tokens are tokens where the client ID of the token handling client is present in the token handler list element.

### FIELD OF THE INVENTION

The present disclosure relates to a token management system and to a method of managing tokens in such a system.

### BACKGROUND

Tokens are often used representing advantages and such tokens can then be shared, managed, and traded in many different ways and by many different parties. Tokens could e.g., be used to give a discount to some specific selected consumers and are often given as a code that can be entered when buying a product online, but there also exists different methods of using tokens. A problem is that it can be hard to control who uses a token while also limiting which persons used the token both in numbers and time.

Today, sharing may be done by sending out a discount code by email, phone number etc. This code may then be used by anyone knowing the code and not only the users it was intended for. Thus, it is difficult to control and manage the token after it has been given to a user. Another problem by sharing tokens is that you cannot change the token after it has been shared, such changes could be completely withdrawing the token or changing the value represented by the token e.g., changing a discount from 25% to 35% or limiting the access to the token for some receivers.

Examples of a token managing system are disclosed in US2010235882A1, which are incorporated in the present disclosure by reference.

### A SUMMARY OF THE INVENTION

A first aspect of the present disclosure is a token managing system for managing tokens. The system comprising a token control server with a token database. The system further comprises a plurality of token handling clients for handling the tokens. Each token handling client being uniquely identifiable via a client ID. The tokens are defined in the token database of the token control server and each token comprises the following data elements:
a token ID element uniquely identifying the token,
a token description element describing features of the token,
a token handler list element identifying the client ID of a plurality of token handling clients.

The token handling clients identify a handler specific list of available tokens, the tokens are tokens where the client ID of the token handling client is present in the token handler list element.

A handler specific list of available tokens is a list of tokens for which the client ID of the token handling client is listed in the list of client IDs with access to that token.

By having a token managing system with a central control server having a database controlling the tokens and the availability of the tokens gives the total control of the offers of tokens like services, discounts, or products. The person that offers a token can completely control which other users the token should be available to. Thus, the user has complete control of the distribution and accessibility of a token. This control is due to the database where all information of who has access to which tokens are stored, and tokens are checked, used, or handled. The system uniquely manages tokens and may do so in detail for each user. The token management system is unique due to the distribution of access to tokens via client IDs among other things.

Another advantage of this system is that the connections you can make in the system are secure and trusted as the users need to verify their unique client ID.

A third advantage is that the token handling clients do not need to store any information or do a lot of processing as this is handled by the central control server.

In embodiments the token managing system for managing tokens, the system comprising a token control server with a token database and where the system further comprises a plurality of token handling clients for handling the tokens. Each token handling client being uniquely identifiable via a client ID, wherein tokens are defined in the token database of the token control server and each token comprises the following data elements:
a token ID element uniquely identifying the token,
a token creator client ID,
a token description element describing features of the token,
a token handler list element identifying the client ID of a plurality of token handling clients.

The token handling clients configured to identify a handler specific list of available tokens, said tokens are tokens where the client ID of the token handling client is present in the token handler list element.

A token handling client may be configured to identify a handler specific list of available tokens by accessing the token database, searching for all tokens where the ID of the token handling client is listed in the token handler list element. The corresponding token IDs or other token data may be sent to the token handling client and may be displayed to a user.

In an embodiment, the handler specific list of available tokens also includes the token description element of the token.

By including the description element of the token such that the description can be seen when available tokens are displayed the users with access to the token may understand better what the value of the token is. This adds a data element for what information is shared in the token managing system.

In an embodiment, the token further comprises a data element being a token handling status element indicating how many times the token has been handled by a token handling client.

In an embodiment, the indication of handling comprises indicating how many times the token has been forwarded from one token handling client to another token handling client.

By having a data element counting how many times a token has been handled, the token provider can follow the distribution of the token and may have set a value of a maximum number of token handling clients that can handle the token. Thus, the availability of the token can be controlled by using this data element.

In an embodiment the indication of handling comprises an indication of how many times the token has been used by the token handling client.

The token can be set to be used a certain number of times for each token handling client by using this indication of how many times the token has been used by the token handling client.

In an embodiment, the token further comprises a data element being a token limiting timer element indicating a time interval wherein a token should be available in the handler specific list of available tokens identified by the token handling client.

This token limiting timer data element gives the possibility of controlling at which time the token is available. The time may be an interval with a start time and an end time, or a sequence like e.g., every Monday at 10-12.

In an embodiment, the token further comprises a data element being a token position limiter indicating a geographical position of the token handling client where the token is available in the handler specific list of available tokens identified by the token handling client.

By including a position-limiting element the token's availability can be controlled by the geographical position of the token handling client. The limitation may, e.g., be an area where the token is available or within a certain distance from a geographical point like a store.

In an embodiment, the token control server and said plurality of token handling clients comprises means for synchronizing data elements of the tokens in the token database of the token control server with the corresponding token items in the handler specific list of available tokens identified by each of the token handling clients.

By having a means for synchronizing data elements and the elements shown in a handler specific list it is ensured that the handler specific list shows the available tokens and not tokens that may be unavailable due to e.g., a time limit. The availability of a token may be checked further at the server when a token is used.

In an embodiment, the token handling client is a wireless computing device.

A second aspect of the present disclosure is a method for managing tokens by a token managing system. When a client ID is removed from said token handler list element in the token database, then the token item is removed from the handler specific list of available tokens identified by said token handling client.

The token item may also be denoted the token as it describes the token data.

The method described above can control the access to tokens on the level of individuals and the access to a token may be withdrawn for a user if desired by the token provider. Thus, there is total control of the distribution of tokens.

In an embodiment of managing tokens, when a token description element is amended, then in the handler specific list of available tokens identified by said token handling client, description of the shown tokens with the same token ID are amended correspondingly.

By amending the description of the shown tokens in the handler specific list it is ensured that the description of the token when viewed by a user is not outdated.

In an embodiment of the method of managing tokens, a token item created by a first token handling client can be shared or forwarded to a second token handling client to be made available to the second token handling client by performing the steps of:
from the first token handling client communicating the token ID of the token item to be forwarded and the second client ID to the token control server,
at the token control server adding the client ID of the second token handling client to the token handler list of the token item for transfer.
at the second token handling client adding the token item to the list of available token items by connecting to the database and search for tokens having the second token handling clients ID in the token handler list.

By using the described method, a method for distributing tokens to other users is established. At the same time the token provider will be able to edit the list of client IDs with access to the specific token if the token provider so desires. Thus, a method of distributing tokens while maintaining control of the access to the tokens is established.

An alternative method for distributing access to tokens is to provide a group or a community of token handling clients with access to a token. A group is multiple token handling clients forming a group. A token handling client can then give, share, and provide access to a token for all members of the group. Thus, adding all members can be done in one step instead of adding all the members one by one. The system may give a warning if a token handler client adds a group to the token handler list but one of the token handler clients in the group is on the list of token handler clients not having access to the token. The list of client IDs for token handler clients not having access to a token may overrule when a group of client IDs is added to a token handler list. In this way a token provider may ensure that specific token handler clients do not get access to a provided token.

In an embodiment of the method, the token control server further checks transferability in a data element comprised in the data of the token item and only if the token item may be transferred then the client ID of the second token handling client may be added to the token handler list of the token item. By transferring a token item is meant to make the token item available to another token handling client. Transferability of a token item may describe if the availability of the token can be changed. E.g., there may be a limit of how many token handling clients accessing a token or an ID may be on a list for token handling clients not having access to a token.

In an embodiment of the method of handling tokens, when a token item is being handled by a token handling client, the following steps are performed:
from the token handling client communicating the token ID of the token item to be handled to the token control server,
at the token control server checking the handleability of the token item having the token ID of the token item to be handled,
at the token handling client allowing handling of the token item when receiving acceptance from the token control server.

By including the above steps in the method, the users are capable of using the tokens and get the offered value of the tokens. The method further ensures that only the users with access to the token at the moment of use will be able to use the token.

In an embodiment of the method of handling tokens, the geographical position of the token handling client is transferred to the token control server and allowing handling of the token item depending on a comparison of the geographical position and a token position limiter data element comprised in said token item.

In an embodiment of the method of handling tokens, the time of token handling is communicated to the token control server and the allowing of handling of the token item depends on a comparison of the time and a token limiting timer data element comprised in said token item.

In the following specific examples, according to aspects of the present disclosure, it will be explained in more detail with reference to the accompanying drawings. The present disclosure may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

### SUMMARY OF FIGURES

Embodiments of the present invention will be described referring to the following figures:

FIG. 1 illustrates the elements of a token managing system,

FIG. 2 illustrates an example of how a token is generated and how a user gets access to the token,

FIG. 3 illustrates data elements defining a token in the database of the token control server,

FIG. 4 illustrates an example of token handling clients sharing a token with other token handling clients,

FIG. 5 illustrates an example of storing versions of token data as the token data is changed.

### DETAILED DESCRIPTION OF THE INVENTION

Tokens represent some value that is attributed to the token. The value may be but is not limited to savings, money, discounts, entries, house rental, a haircut and so on. A token is created in the system to represent a real-life advantage like advantages as in front of the cue, discount, early access to purchase opportunities, etc. This means that the value of a token may represent any value. Tokens may be represented and described by data, especially tokens handled by devices comprising a processor like online tokens. Tokens may be offered as desired in order to give value or advantage to creators and/or users of a token.

Tokens describe an advantage and may be created as data and saved in a token database 14. The token database 14 describes a database capable of storing token data, the database 14 may store other data as well. The token database 14 will be denoted as the database 14 throughout this document. Data saved in a database 14 for a token may be saved as token items in a database 14. Tokens may comprise token data elements that represent one or more advantages or values of the token. The token data elements may comprise different information e.g. a description of the advantage, a maximum token handling client redeem limit, a time interval for when the token is available, the token ID, the token creator's client ID, the state of the token, a unique code when redeeming the token, a title, a list of client IDs of token handling clients 24 with access to the token and maybe other data associated with the token 17.

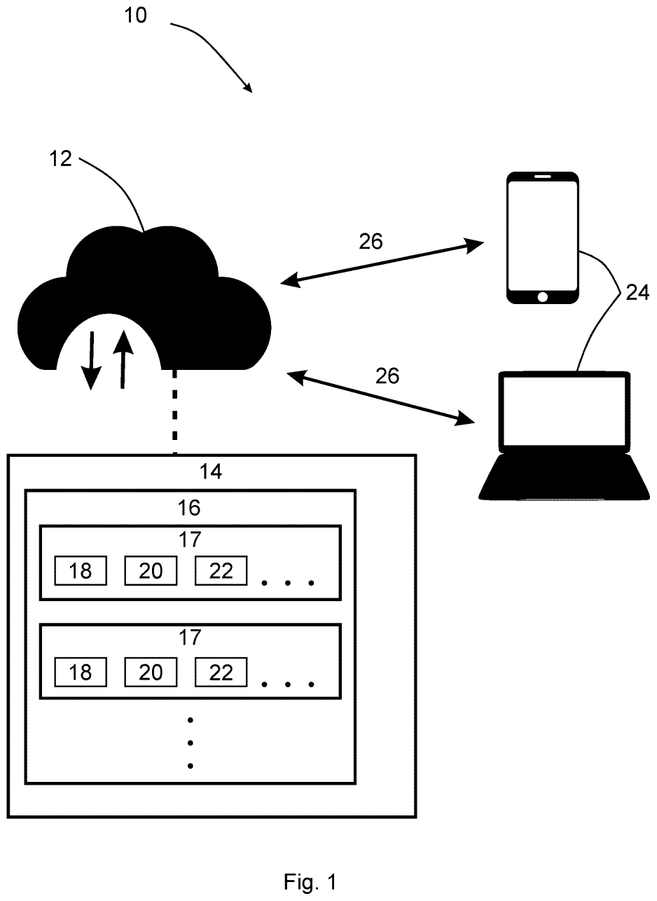

The token managing system 10 is illustrated in FIG. 1. The token managing system 10 comprises a token control server 12 that comprises and controls a database 14. The database 14 comprises token data 16 for multiple tokens 17. Furthermore, the token managing system 10 comprises token handling clients 24 which can communicate 26 with the token control server 12 via communications means. Communication means is defined as means that can send and receive information to an electronic device like a server. The token handling client 24 may comprise a processor and communication means such that the token handling client 24 can communicate/connect to the token control server 12 of the token managing system 10.

A user of the token managing system 10 may use a token handling client 24 to manage and handle tokens in the token database 14. For a user to use a token handling client 24 a user needs to provide a client ID for the token handling client 24 and verify the client ID. Hereafter the user is able to connect to the token control server 12 and access data from the database 14 through the token handling client 24. For a first token handling client to get access to a token, the token needs to be provided by a second token handling client. The second token handling client needs to include the client ID of the first token handling client in the list of token handling clients with access to the provided token. Now the first token handling client will have access to the token and is able to see what value it describes. The second token handling client will always be able to add or remove client IDs from the list of token handling clients with access to the token to control who can use and see and access the token and who cannot.

A user wanting to use a token may redeem the token in order to get the described value of the token. The term redeeming a token is one way of handling a token. The handling of a token may be done by a token handling client 24 and may e.g., use, edit, remove, or re-share the token. It may only be the token creator that will be able to edit the token and the token data, and remove a token, this may e.g. be by adding a client ID to the list of client IDs with access to this token. Non token creators will be able to see a token if their client ID is on the list of client IDs for the token and may choose to redeem the token.

In embodiments the token creator may add other token handler clients as co-creators meaning that the data for the token creator stored in the database may be a list of token creators, these token handling clients being able to edit and share the token.

The token provider may give control to token handling clients with access to a token to re-share the token, meaning being able to add other client IDs to the token handler list of the token. This will be described in more detail in another section. Redeeming a token means that the token is converted into the described value. The value of a token may be:
a free entry to a nightclub to get access to the nightclub,
a discount on a product,
a free haircut at a hairdresser,
a service,
a rental of a home
etc.

Thus, to redeem a token it is meant that a person uses the token and converts it into the value described by the token. An example of how this value could be represented is in a receipt representing the value of the token e.g., a receipt comprising a code/keyword for use in a store etc. The receipt may comprise text, numbers, a QR code, a barcode and/or other data such as a ticket to access a physical place.

When redeeming a token, the user either gets the described value of the token or a receipt that the token is reserved for use only by the user redeeming the token. The token may be redeemed and afterwards another person e.g. the token provider or an employer of the token provider may need to verify that the value has been given to the user. This may e.g., be at a bar where a user redeems a free entry when the user sits a home. Now the user may go to the bar and the doorman may verify that the token has been used. Thus, a token may be redeemed and furthermore, the redeeming may be verified but verification is not necessary for redeeming a token. The following described criteria or limitations for redeeming may also apply to the verification of the redeeming of a token.

A token comprises different token data elements including some of the following token data elements:
a token description element describing the advantage represented by the token,
a token limit element describing a limit of how many times in total and how many times per user a token can be redeemed,
a token handler list element identifying the client ID of a plurality of token handling clients for which the token is available,
a token ID,
a token creator ID

The token description element is information about the token and the advantage a user can get by using the token. This may be represented by text, numbers, one or more images, one or more videos, or other standard means for representing information.

The token limit element is used for limiting how many users that can redeem a token and may be represented by a number from 1 to infinity. If the token limit is reached for a token, the token will no longer be available for token handling clients 24 to redeem. The token limit can also be how many times one person can redeem a token.

The token may be set to have the ability to re-share to a user's own network. Say a user creates and distributes a token to a set of users, then the creator of the token can set an ability to allow the receivers to re-distribute the token to their network.

The token may have an in-person validation ability. Said token can be distributed to a group of users. These users have the possibility to redeem the token and when they e.g. arrive to the entrance a person can validate the token and thereby set it to a new status such as “used token” and e.g. let the user in through the door.

The token may always comprise information regarding when it is valid. So, it has a start time and an expiration time. It can expire before time if the limit in numbers for the token is reached, or the token creator removes/deletes the token. The time period for a token may be set automatically e.g. to when the token is created and until the creator removes the token.

The token handler list element identifying client IDs may comprise a number of token handling client IDs from zero to the number of all token handling clients registered with a client ID in the database 14. A client ID is an information that has been verified by the user and uniquely represents the token handling client 24. The client ID may be a user's phone number, email address, name and address or another unique identifier.

A token ID is an element that uniquely identifies the token. That may be a unique set of numbers or characters.

A user wanting to offer a token may use a token handling client 24 to generate a token by providing token data elements for this token 17 and save the token data in a database 14. Generating a token will also be denoted creating a token throughout this document. The token handling client 24 generating the token will be denoted as the token provider, the token generator, or the token creator. The client ID for the token provider may be saved in the database 14 for each generated token.

In embodiments the token creator's ID needs to be stored as token data in the token database 14 as this information may allow the token creator to edit and/or remove the token. The token creator ID stored for each token may give access for the token creator as the ID of the token handling client having created the token match the token creator ID stored in the database 14. Thus, no other token handling clients 24 than the token creator or token creators if multiple will be able to edit a token.

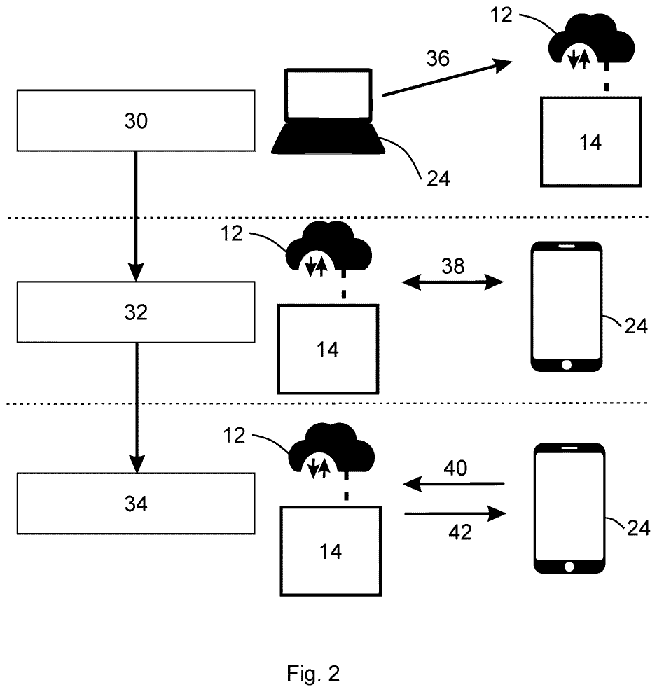

A method describing how a token is created or generated, made available to other users, and redeemed by another user is illustrated in FIG. 2. in three steps. The first step 30 comprises creating a token. The token data may be saved on a token control server 12 by saving each token in a separate row of an array in the database. The user offering a token may via a token handling client 24 type in the token data in an application on a device with a processor with the ability of connecting 36 to the token control server 12. When the token data has been typed in or otherwise provided, the device connects 36 to the token control server 12 and updates the database 14 with the provided token data. The token data elements include a token handler list of client IDs of the token handling clients 24 that has access to the token. The list may be empty until the token provider adds token handling client IDs, no token handling clients will have access to the token before an ID is added to the list of client IDs.

This way multiple creators can create different tokens which are all stored in the database 14 and the users with their client ID in one or more token handler lists have access to corresponding tokens.

In step 32 a token handler client 24 being identified by the client ID in one or more token handler lists can then connect 38 to the database 14 and look up which tokens are available to the user at that moment. In this way, the token handling client 24 will create a handler specific list of available tokens. The token handler client 24 used by the user may be a mobile phone, a computer, a processor, tablet, or another electronic device comprising a processor and communication means. The connection between the device and the database 10 may be through a network, that is either wireless or cabled. Any standard encrypted network connection and protocols like TLS/SSL, IPsec or SSH may be used. Thus, in order for a user to get access to a specific token, the client ID needs to be listed in the token data for that token.

A user can see the available tokens for a specific token handling client 24 by connecting the token handling client 24 to the token control server 12 connected to the database 14. The token control server 12 can look through the database 14 and send all the available tokens to the token handling client 24 such that the user can review the available tokens in a handler specific list of available tokens. Thus, when the user uses a token handling client 24 to see available tokens, the user has access to the available tokens trough the token handling client 24. At all times a user can decide to use the advantage describe by an available token by redeeming the token using the token handling client 24.

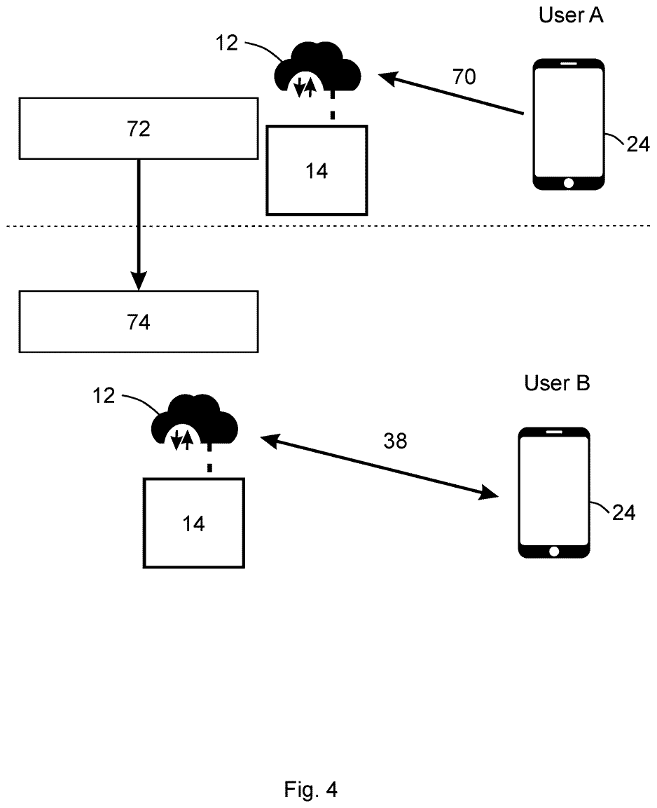

After a token has been created in the database, users with access to the token may redeem the token. Another possibility for a user with access to a token is to re-share or re-distribute the token to other token handling clients 24. This is illustrated in FIG. 4. Re-sharing a token means that one or more new token handling clients 24 will get access to the token. This is done by adding the new token handling client 24 client IDs to the token handler list in the token data as illustrated in step 72 of FIG. 4. Now when the new users through a token handling client 24 look up what tokens are available to them in the database the re-shared token will be visible as illustrated in step 74.

The token provider may set a re-sharing limit describing how many times the token can be re-shared by token handling clients 24. The token provider may also set a limit on how many times a re-shared token can be re-shared. A re-shared token may be re-shared in the case where token handling client A create a token. Token handling client A then shares the token with token handling client B. Token handling client B re-shares the token with a new token handling client C, whom did not have access to the token from token handling client A. Then token handling client B has re-shared the token once. Now token handling client C may re-share the token with token handling client D and is thereby re-sharing the token twice. By setting a re-sharing limit, the creator can control how many times a token can be re-shared or if the token can be reshared at all. Thus, the re-share limit is an additional data element that may be part of the token data in the database 14.

If the token is set by the token provider to be re-shareable, other token handling clients having their client ID on the list of client IDs for a token will be able to add other client IDs to the list of client IDs. In this way not only the token provider will be able to control and edit the list of client IDs for a token.

The token provider may also set a limit on how many token handling clients can re-share a token. This limit controls how many token handling clients re-share the token. The token provider may be able to set a limit for how many token handling clients having access to the token and it may not matter if the token is shared directly from the provider or from a token handling client having re-shared the token.

The token provider may set a re-share limit of how many times a token can be re-shared, meaning if a token handling client re-shares a token, one of the receivers of this re-shared token can re-share the token again. The re-share limit is stored in the token data and determines how many times a token may be re-shared. This re-share limit should not be confused with how many client IDs can be added to the token handler list of client IDs for token handling clients being able to re-share a token. E.g., a token creator provides a token which may be re-shared once and every token handling client re-sharing the token can re-share to ten other token handling clients. Moreover, the total number of token handling clients having access to the token may be set to forty token handling clients.

A user with access to a token can decide to use the token and redeem it to get the advantage described in the token. This is illustrated in the step 34 in FIG. 2. When a user redeems an available token the token handling client 24 connects 40 to the token control server and requests a redeem of the token. The token control server 12 do a check in the database confirming the availability of the token for the token handling client 24. If the token is available, the token control server 12 send a receipt 42 to either the token handling client 24 of the user redeeming the token or the token handling client of the token provider. The receipt 42 may be sent to both the user redeeming the token and the token provider. The receipt may comprise a confirmation that the redeem has been made successfully and/or the token providers given proof that the user can use the advantage. The proof that the user can get the advantage or value described by the token may be a code that can be used. If the token is for multiple users, the code may be the same for each user and the limit for uses can be set by the token provider to the number of multiple users or multiple specific codes could be made different for each user.

In an embodiment a receipt of the redeem is only sent to the token provider.

To redeem a token the token handling client needs to be connected to the token control server 12 and database 14 to check validity. This is necessary since the token could have been removed from the token handler list of the token data in the database. Thus, the access to a token is controlled centrally in the database 14 through the token control server 12.

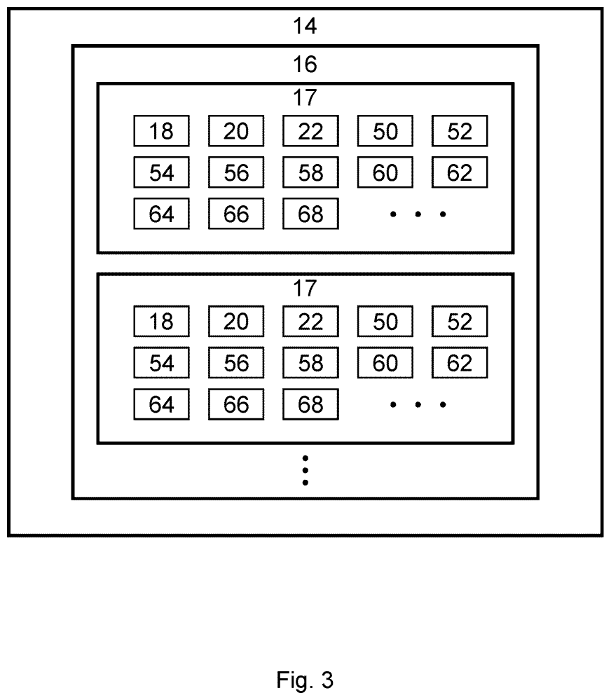

When a token is generated, additional token data 16 for the token can be saved in the database 14. This is illustrated in FIG. 3, the database 14 comprises token data 16, which comprises token items with data for each token. The data for a token 17 comprise:
a token ID 18,
a token description 20,
A token handler list of client IDs 22 with access to the token 17.

The token 17 may further comprise one or more of the following data elements:
token owner ID 50,
token cover image ID 52,
token title 54,
token code 56,
token requirement 58,
valid start time of token 60,
expiry time of token 62,
token state 64,
user's redeeming limit 66,
a geographic limitation 68 of the availability of the token 17,
a token information description if the token can be re distributed from the receiving user to the user's network,
a token validation information comprising information if a user is needed to validate the token to enter a certain place.

This data may be stored for every token 17. More elements can be added as a data element in the token if desired.

The token owner ID 50 is the client ID of the token handling client that created or generated the token. This data may be used to control if a token handling client can edit a token, and this may be set to be only the token creator that can edit a token and the token data. A token handling client may connect to the token database 14 and look up which tokens this token handling client is the creator of, and obtain a list of these tokens. The token handling client may edit and/or remove tokens in this list of created tokens. The database 14 may be set up such that only the token creator may be able to edit the token data. There is one exception to this and that is if a token is re-shareable then token handling clients with access to a re-shareable token may also add client IDs to the token data. These client IDs may be removed again either by the creator or the token handling client who re-shared the token.

The token cover image ID 52 is the ID of the cover image that should be displayed when a user is inspecting a token in order to decide if the user wants to redeem the token. The cover image may be saved in the database and given an ID when the token is created. Thus, if the cover image is used multiple times in the system, the data for the image only needs to be stored once in the database 14.

The token code 56 is the receipt, code, or keyword the token creator chooses to give to users redeeming the token.

The token requirement 58 describes the requirements for redeeming a token if any requirements are applicable. Such requirement for redeeming a token may include minimum of age, gender requirement, etc.

The token state 64 describes the state of availably of the token, thus, if the token is available, deleted, hidden or payment is awaiting or completed. For example, this may be useful if you need to have made a payment for the token to be available.

The geographical limitation 68 for where a token is available describes the area where only users within the geographical area has access to the token. This is another limitation for availability. Tokens can be created such that users need to fulfil all the conditions of availability in order to have access to a token like client ID, geographical limit, time limit and so on. The geographical limitation may apply to a redeemed token, such that the user may only be able to show the receipt or code for the token in a specific area.

In an embodiment, the token creator/provider decide which limitations need to be fulfilled for a token handling client to have access to a token.

The additional token data may be a limit 66 on how many token handling clients can redeem the token. Thus, when a token is redeemed by one token handling client the database is updated such that a count of how many redeems have been used for this token. If the limit of the number of redeems set by the token provider is reached, the token is not to be available to the token handling clients, whom have been offered the token but have not yet redeemed the token.

The availability of all tokens is thereby controlled centrally by the token control server comprising the database. This means that the access to tokens and connections between token handling clients can be controlled easily by the token provider and changed at any given time if so desired. The system gives control of the visibility of a token on the level of specific token handling clients. This increases the control of privacy for each user as the user is then always able to control which client IDs have access to the token handling client's token.

The token provider or token handling client 24 may further set a time limit for when the token is available by defining a start 60 and end time 62 of the availability of the token 17. This would include that the token provider provide data for when the token is available. This may be by saving a start time and an end time for the availability of the token in the token data. Now the token handling clients who are offered this token only have access to it in the provided time interval.

In one embodiment the token may be invisible to the desired token handling clients outside the provided time interval.

In another embodiment the token is visible before it is available for use and the user can see the time interval for when the token is available.

The token may be removed or made invisible after the end time of the time interval has passed.

By hiding the token for receivers when the time interval is over, the token provider may change the token data in order to make the token available again either as the same token or an edited version. This may make it easier for token providers to provide new tokens from already generated token data.

The token data may include a list of client IDs for token handling clients who cannot get access to the token. This can be used if a user is misusing tokens by e.g., redeeming to many or resharing tokens to more people than intended. Thus, if a token handling client A shares a token with a token handling client B and token handling client A thinks that token handling client B misuse the token. Then token handling client A can update the token data for the token in the database to include token handling client B's client ID in the list of token handling clients who do not have access to the token.

Another possibility of the token managing system is if a token handling client A does not want tokens from a specific token handling client B, as the token handling client B may be offering a lot of tokens, the token handling client A may block tokens from the specific token handling client B. This is technically implemented by storing token handling client B's client ID in the data for token handling client A in a place describing blocked token handling clients. Thus, when user A uses the token handling client to look in the database for available tokens, the server 12 finds all the available tokens and removes the tokens from token handling clients found in the list of blocked token handling client in the data for token handling client A.

The token provider may edit the token data if desired after the token data has been generated. Thus, the token provider may remove the token, change the limit of how many token handling clients can use the token, change the value of the token, change the description of the token, change the time interval for when the token is available, change the availability of the token, and edit the list of token handling clients with access to the token.

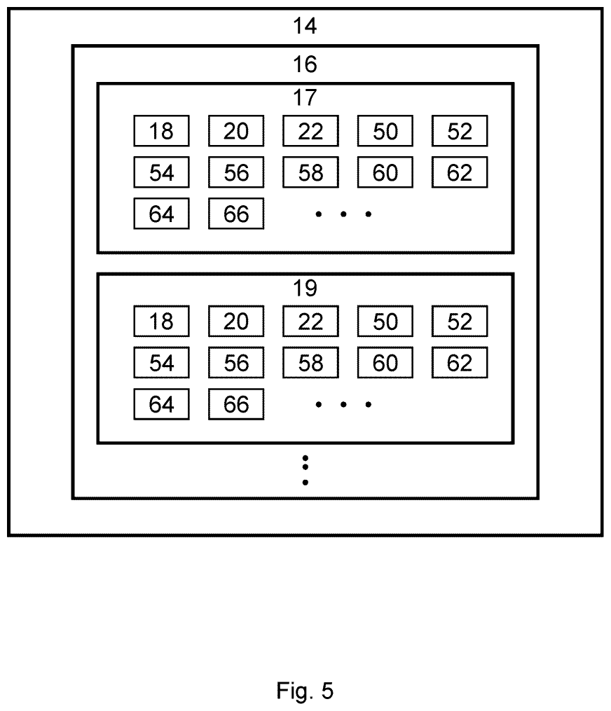

When editing an available token, problems such as what token did a user redeem if the user redeemed the token before or after the editing of the token. To handle such problems, different versions of the token are stored in the database. This is illustrated in FIG. 5. Thus, the original token 17 is stored when the token is generated by the provider. If the token is edited to e.g., having less redeems or a new availability time interval, the original token 17 is saved as well as the new token 19. Thus, multiple versions of the token are stored. Now, if a user redeemed the original token the user is through the token handling client able to see what was redeemed and the token handling client will connect to the database and look up the original token data. If another user redeemed the token after an edit of the token, this user will be able to look up the updated token data to see what the user redeemed. Thus, these two users will see the token as two different tokens, which are two different versions of the same token.

When a user is off-line, meaning that the token handling client has no connection to the token control server comprising the database, and is redeeming a token, the request for redeeming the token will be sent to the token control server as soon as the token handling client gets connection to the token control server. Thus, a user cannot redeem a token when being off-line, but the user can request a redeem off-line and get it verified or cancelled when the request is managed by the token control server 12.

If a user redeems a token, the user will get a receipt. The receipt may be a code, that can be used. This may be in a coffee shop, which created this token and therefore knows the code or receipt given to the user. The user redeemed e.g. the free coffee cup when going online and afterward got the receipt, and will now be able to go to the coffee shop without any connection to the token control server and use the receipt to get a free cup of coffee.

When creating/generating a token the token creator/provider may get a preview of the token displayed in order to be able to check if the token data is correct and describes the advantage it represents correctly. Thus, the token creator can see how the token is presented to users with access to the token.

### LIST OF REFERENCE NUMBERS

10 Token managing system
12 Token control server
14 Database
16 Token data
17 Token
18 Token ID
19 New version of specific token data
20 Token description
22 Token list of user IDs
24 Token handling client
26 Communication connection to server
30 The step of generating a token
32 The step of look up available tokens for a user
34 The step of redeeming a token
36 Send token data to token control server
38 Connect a client device to the token control server and lookup tokens available
40 Send a request for redeeming a token
42 Send a receipt to the client device
50 Token owner ID
52 Token cover image ID
54 Token title
56 Token code
58 Token requirement
60 Valid start time of token
62 Expiry time of token
64 Token state
66 User redeem limit of token
68 Geographic limitation
70 Connecting to the token control server and add user B's ID to the token list of user IDs.
72 Re-sharing a token
74 Look up available tokens via the token control server

1. A token managing system for managing tokens, said system comprising a token control server with a token database and where the system further comprises a plurality of token handling clients for handling said tokens, each token handling client being uniquely identifiable via a client ID, wherein tokens are defined in the token database of the token control server and each token comprises the following data elements:
a token ID element uniquely identifying said token,
a token creator client ID,
a token description element describing features of said token, and
a token handler list element identifying the client ID of one or more token handling clients,
said plurality of token handling clients configured to identify a handler specific list of available tokens, said available tokens being tokens where the client ID of the token handling client is present in the token handler list element.

2. The token managing system according to claim 1, wherein said handler specific list of available tokens also includes the token description element of the token.

3. The token managing system according to claim 1, wherein each token further comprises a data element being a token handling status element indicating how many times the token has been handled by a token handling client.

4. The token managing system according to claim 3, wherein said token handling status element indicates how many times the token has been forwarded from one token handling client to another token handling client.

5. A The token managing system according to claim 3, wherein said token handling status element indicates how many times the token has been used by the token handling client.

6. The token managing system according to claim 1, wherein said token further comprises a data element being a token limiting timer element indicating a time interval during which a token should be available in the handler specific list of available tokens identified by the token handling client.

7. The token managing system according to claim 1, wherein said token further comprises a data element being a token position limiter indicating a geographical position of the token handling client where the token is available in the handler specific list of available tokens identified by the token handling client.

8. The token managing system according to claim 1, wherein said token control server and said plurality of token handling clients comprises means for synchronizing data elements of the tokens in the token database of the token control server with corresponding token items in the handler specific list of available tokens identified by each token handling client.

9. The token managing system according to claim 1, wherein said token handling client is a wireless computing device.

10. A method for managing tokens by a token managing system, said system comprising a token control server with a token database and where the system further comprises a plurality of token handling clients for handling said tokens, each token handling client being uniquely identifiable via a client ID, wherein tokens are defined in the token database of the token control server and each token comprises the following data elements:
a token ID element uniquely identifying said token,
a token creator client ID,
a token description element describing features of said token,
a token handler list element identifying the client ID of one or more token handling clients,
said plurality of token handling clients configured to identify a handler specific list of available tokens, said available tokens being tokens where the client ID of the token handling client is present in the token handler list element, the method comprising:
when a client ID is removed from said token handler list element of a token item in the token database, removing the token item from the handler specific list of available tokens identified by said token handling client.

11. The method according to claim 10, further comprising wherein when a token description element is amended, amending, in the handler specific list of available tokens identified by said token handling client, a description of tokens with the same token ID.

12. The method according to claim 10, further comprising forwarding a token item at a first token handling client to a second token handling client by performing the steps of:
from the first token handling client, communicating a token ID of the token item to be forwarded and a client ID of the second token handling client to the token control server,
at the token control server, adding the client ID of the second token handling client to the token handler list element of the token item having the token ID of the token item to be transferred, and
at the second token handling client, adding the token item to the list of available tokens.

13. The method according to claim 12, further comprising checking, by the token control server, transferability in a data element of the token item, wherein only if the token item is permitted to be transferred is the client ID of the second token handling client added to the token handler list element of the token item.

14. The method according to claim 10, further comprising the following steps when a token item is being handled by a token handling client:
from the token handling client, communicating a token ID of the token item to be handled to the token control server,
at the token control server, checking the handleability of the token item having the token ID of the token item to be handled, and
at the token handling client_ allowing handling of the token item when receiving acceptance from the token control server.

15. The method according to claim 14, further comprising informing a geographical position of the token handling client is to the token control server and allowing handling of the token item depending on a comparison of the geographical position and a token position limiter data element included in said token item.

16. The method according to claim 14, further comprising communicating a time of token handling to the token control server and allowing handling of the token item depending on a comparison of the time and a token limiting timer data element included in said token item.

17. A non-transitory machine-readable medium, comprising executable instructions that, when executed by a processor of a token managing system, facilitate performance of operations, said system comprising a token control server with a token database and where the system further comprises a plurality of token handling clients for handling tokens, each token handling client being uniquely identifiable via a client ID, wherein tokens are defined in the token database of the token control server and each token comprises the following data elements:
a token ID element uniquely identifying said token,
a token creator client ID,
a token description element describing features of said token,
a token handler list element identifying the client ID of one or more token handling clients,
said plurality of token handling clients configured to identify a handler specific list of available tokens, said available tokens being tokens where the client ID of the token handling client is present in the token handler list element, the operations comprising:
when a client ID is removed from said token handler list element of a token item in the token database, removing the token item from the handler specific list of available tokens identified by said token handling client.

18. The non-transitory machine-readable medium according to claim 17, wherein said handler specific list of available tokens also includes the token description element.

19. The non-transitory machine-readable medium according to claim 17, wherein each token further comprises a data element being a token handling status element indicating how many times the token has been handled by a token handling client.

20. The non-transitory machine-readable medium according to claim 19, wherein said token handling status element indicates how many times the token has been forwarded from one token handling client to another token handling client.
